(19) United States
(12) Patent Application Publication
(10) Pub. No.: US 2019/0073380 A1
(43) Pub. Date: Mar. 7, 2019

(54) Acreage Map Generation Using Indirect Information Sources

(71) Applicant: Drilling Info, Inc., Austin, TX (US)

(72) Inventors: Ajit Thomas, New York, NY (US); Yashodeep Deodhar, Bangalore (IN)

(21) Appl. No.: 16/121,913

(22) Filed: Sep. 5, 2018

(30) Foreign Application Priority Data
Sep. 5, 2017 (IN) 201741031335

(51) Int. Cl. G06F 17/30; G06Q 50/16; G06T 11/20; G06F 15/18

(52) U.S. Cl. CPC G06F 17/30241; G06F 15/18; G06T 11/203; G06Q 50/163

(57) ABSTRACT

A method is performed at a computing system having one or more processors and storage media storing instructions for execution by the one or more processors. The method includes obtaining a digital version of a state filing pertaining to a deal involving transacted acreage. The method further includes obtaining metes and bounds or other like description of the transacted acreage from the digital version and using the metes and bounds or the other like description to generate a geographic information system shapefile specifying non-topological geometry of the transacted acreage; and using the shapefile to cause the geographic information system to display a map that visually indicates at least boundaries of the transacted acreage as one or more polygons overlaid on the map display.

### CROSS-REFERENCE TO RELATED APPLICATION

This application claims priority under 35 U.S.C. § 119 to Indian Patent Application No. 201741031335, filed on Sep. 5, 2017, the entire contents of which are incorporated by reference herein.

### TECHNICAL FIELD

The disclosed implementations relate generally to digital maps, and, in particular, to computer-implemented techniques for generating acreage maps using indirect information sources.

### BACKGROUND

For competitive intelligence reasons, upstream oil and gas companies desire to track the business development activities of other companies in their industry. Among other things, they desire to track the deals completed by their competitors to buy and sell acreage, as well as, the current acreage held by their competitors. Each competitor's current acreage may be a result of leasing activities and deals completed, such as acquisitions and divestitures.

These upstream oil and gas companies, as well as consultants and investment bankers that serve as advisors to them, typically make use of existing third-party databases that compile information on oil and gas deals and sell the information to the companies as a competitive intelligence offering. The existing third-party database providers typically source their data directly from the parties to the deals including from public disclosures (e.g., press releases) by the parties and from information provided by the parties to the third-party database providers. However, there are many deals for which limited or no public disclosures are made by the parties or for which the parties do not provide information to the third-party database providers. Nonetheless, for competitive intelligence reasons, companies desire the ability to discover and track such deals.

### SUMMARY

Accordingly, there is a need for techniques for compiling and surfacing information on deals involving transacted acreage for which information is not directly provided by the parties to the deals, either as a public disclosure or to a third-party competitive intelligence database provider. By identifying state filings pertaining to deals, using a machine-learning algorithm to classify the state filings, party and acreage information is extracted from the relevant state filings and used to generate digital geospatial maps reflecting acreage transacted in the deals. Such techniques optionally complement or replace conventional techniques for generating maps.

In accordance with some implementations, a method is performed at a computing system having one or more processors and storage media storing instructions for execution by the one or more processors. The method includes obtaining a digital version of a state filing pertaining to a deal involving transacted acreage. The method further includes obtaining metes and bounds or other like description of the transacted acreage from the digital version and using the metes and bounds or the other like description to generate a geographic information system shapefile specifying non-topological geometry of the transacted acreage; and using the shapefile to cause the geographic information system to display a map that visually indicates at least boundaries of the transacted acreage as one or more polygons overlaid on the map display.

In accordance with some implementations, a computing system includes one or more processors and storage media storing one or more programs configured to be executed by the one or more processors. The one or more programs include instructions for performing the operations of the method described above. In accordance with some implementations, a non-transitory computer-readable storage medium has stored therein instructions that, when executed by the computing system, cause the computing system to perform the operations of the method described above.

In an example implementation, a computer-implemented method is performed by a computing system comprising one or more processors and storage media. The storage media stores one or more programs executed by the one or more processors to perform the method. The method includes obtaining a property transaction record and a survey map and storing the property transaction record and the survey map in a database; parsing the property transaction record to generate property transaction data and storing the property transaction data in the database; identifying property information comprising, at least in part, one or more properties using the property transaction data; generating a plurality of polygons representing the one or more properties using the property information and the survey map; generating a transaction map of the property transaction record using the plurality of polygons and storing the transaction map in the database; and in response to user input, displaying, in a graphical user interface (GUI), the transaction map stored in the database.

In an aspect combinable with the general implementation, obtaining the property transaction record and the survey map comprises accessing a state court website that references the property transaction record and the survey map; and downloading the property transaction record and the survey map through the state court website.

Another aspect combinable with any of the previous aspects further includes identifying, through the parsing, an identification of two or more parties to a property transaction associated with the generated property transaction data.

In another aspect combinable with any of the previous aspects, generating a plurality of polygons representing the one or more properties using the property information and the survey map comprises extracting acreage information from the generated property transaction data; mapping the extracted acreage information to a geospatial database associated with the generated property transaction data; and mapping geospatial information from the geospatial database to a non-topological geometry that defines the shape and outline of each of the plurality of polygons.

In another aspect combinable with any of the previous aspects, the geospatial information comprises data associated with at least one of geographic coordinates or vectors.

In another general implementation, a data processing system includes one or more hardware processors; one or more memory modules communicably coupled to the one or more hardware processors; and an execution system operable on the one or more hardware processors to perform operations. The operations include obtaining a property transaction record and a survey map and storing the property transaction record and the survey map in a database; parsing the property transaction record to generate property transaction data and storing the property transaction data in a structured database stored on the one or more memory modules; identifying property information comprising, at least in part, one or more properties using the property transaction data; generating a plurality of polygons representing the one or more properties using the property information and the survey map; generating a transaction map of the property transaction record using the plurality of polygons and storing the transaction map in the structured database; and in response to user input, displaying, in a graphical user interface (GUI), the transaction map stored in the database.

In an aspect combinable with the general implementation, the operation of obtaining the property transaction record and the survey map comprises accessing a state court website that references the property transaction record and the survey map; and downloading the property transaction record and the survey map through the state court website.

In another aspect combinable with any of the previous aspects, the execution system is operable on the one or more hardware processors to perform operations further including identifying, through the parsing, an identification of two or more parties to a property transaction associated with the generated property transaction data.

In another aspect combinable with any of the previous aspects, the operation of generating a plurality of polygons representing the one or more properties using the property information and the survey map comprises extracting acreage information from the generated property transaction data; mapping the extracted acreage information to a geospatial database associated with the generated property transaction data; and mapping geospatial information from the geospatial database to a non-topological geometry that defines the shape and outline of each of the plurality of polygons.

In another aspect combinable with any of the previous aspects, the geospatial information comprises data associated with at least one of geographic coordinates or vectors.

In another general implementation, a computer-method is performed by a computing system comprising one or more processors and storage media. The storage media stores one or more programs executed by the one or more processors to perform the method. The method includes obtaining a digital version of a state filing pertaining to a deal involving transacted acreage; obtaining metes and bounds description of the transacted acreage from the digital version; using the metes and bounds description to generate a geographic information system shapefile specifying non-topological geometry of the transacted acreage; and using the shapefile to cause the geographic information system to display a map that visually indicates at least boundaries of the transacted acreage as one or more polygons overlaid on the map display.

In an aspect combinable with the general implementation, the state filing comprises an assignment, or an assignment and bill of sale.

In another aspect combinable with any of the previous aspects, obtaining the digital version of the state filing is based, at least in part, on automatically downloading the digital version of the state filing from a website.

In another aspect combinable with any of the previous aspects, obtaining the digital version of the state filing is based, at least in part, on using a machine learning binary classifier to classify the state filing is either a) relevant or b) not relevant to a deal involving transacted acreage.

In another aspect combinable with any of the previous aspects, the digital version of the state filing is text based.

In another aspect combinable with any of the previous aspects, processing the digital version of the state filing is based, at least in part, on parsing text of the digital version of the state filing to extract from the state filing the metes and bounds description.

Another aspect combinable with any of the previous aspects further includes performing optical character recognition on another digital version of the state filing to produce the text-based digital version of the state filing.

In another aspect combinable with any of the previous aspects, the metes and bounds description specifies one or more land blocks/sections.

In another general implementation, a data processing system includes one or more hardware processors; one or more memory modules communicably coupled to the one or more hardware processors; and an execution system operable on the one or more hardware processors to perform operations. The operations include obtaining a digital version of a state filing pertaining to a deal involving transacted acreage; obtaining metes and bounds description of the transacted acreage from the digital version; using the metes and bounds description to generate a geographic information system shapefile specifying non-topological geometry of the transacted acreage; and using the shapefile to cause the geographic information system to display a map that visually indicates at least boundaries of the transacted acreage as one or more polygons overlaid on the map display.

In an aspect combinable with the general implementation, the state filing comprises an assignment, or an assignment and bill of sale.

In another aspect combinable with any of the previous aspects, the operation of obtaining the digital version of the state filing is based, at least in part, on automatically downloading the digital version of the state filing from a website.

In another aspect combinable with any of the previous aspects, the operation of obtaining the digital version of the state filing is based, at least in part, on using a machine learning binary classifier to classify the state filing is either a) relevant or b) not relevant to a deal involving transacted acreage.

In another aspect combinable with any of the previous aspects, the digital version of the state filing is text based.

In another aspect combinable with any of the previous aspects, the operation of processing the digital version of the state filing is based, at least in part, on parsing text of the digital version of the state filing to extract from the state filing the metes and bounds description.

Another aspect combinable with any of the previous aspects further includes performing optical character recognition on another digital version of the state filing to produce the text-based digital version of the state filing.

In another aspect combinable with any of the previous aspects, the metes and bounds description specifies one or more land blocks/sections

Thus, systems are provided with effective methods for generating transacted acreage maps using indirect information sources.

### BRIEF DESCRIPTION OF THE DRAWINGS

FIG. 1 shows a portion of an example state filing pertaining to an oil and gas deal.

FIG. 2 shows another portion of the example state filing containing a metes and bounds description of the acreage involved in the oil and gas deal.

FIG. 3 depicts a state grid with blocks/sections involved in the oil and gas deal highlighted.

FIG. 4 provides a portion of a screenshot of a computer-generated geospatial map with color-filled polygons representing blocks/sections that are the subject of various sourced oil and gas deals.

FIG. 5 is a system diagram that illustrates a networked computer system according to some implementations.

FIG. 6 is a flowchart that illustrates a method or algorithm for creating and modifying digital maps and displaying them in a graphical user interface, according to some implementations.

FIGS. 7A-7G are screenshots of various graphical user interfaces that present information on indirectly and directly sourced oil and gas deals, according to some implementations.

FIG. 8A is a portion of another example state filing pertaining an oil and gas deal involving acreage in the State of Wyoming.

FIG. 8B depicts Wyoming state grid with partial acreage involved in the oil and gas deal of FIG. 8A highlighted.

FIG. 9 is a block diagram a hardware machine that may be used in some implementations of the present disclosure.

FIG. 10 is a block diagram of a software system for controlling operation of the hardware machine in some implementations.

### DETAILED DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are used only to distinguish one element from another. For example, a first map could be termed a second map, and, similarly, a second map could be termed a first map, without departing from the scope of the various described implementations. The first map and the second map are both maps, but they are not the same map.

The terminology used in the description of the various implementations described herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The needs identified in the Background section and other needs are addressed with the disclosed computer-implemented techniques for generating transacted acreage maps based on indirect information sources. The techniques are not well-understood or routine in that they do not rely solely on information sourced directly from parties to deals involved in buying, selling, or leasing the transacted acreage. Instead, the techniques leverage indirect information sources such as state filings to generate maps that are not otherwise available through existing computer database systems. The disclosed techniques are specific in that they pertain particularly to compiling and surfacing transacted acreage information for parties to deals involved in buying, selling, or leasing the transacted acreage. The techniques improve computers as a tool for discovering and tracking such transacted acreage that is not otherwise available through existing computer database systems. The techniques may be used in conjunction with or instead of techniques based on information sourced directly from parties to deals involving transacted acreage.

As mentioned above in the Background, there are many deals in which acreage is transacted for which limited or no public disclosures are made by parties to the deals and for which the parties do not provide information to third-party competitive intelligence database providers. The present disclosure recognizes information on such deals may be available in state filings such “Assignment,” “Assignment and Bill of Sale,” and other like documents. In these state filings, a metes and bounds description of the acreage transacted may be given in a tabular or descriptive format.

As used herein, the term “state filing” refers to a document or set of documents filed with a jurisdiction with defined geographical boundaries, such as a city, state, county, country, or other territorial jurisdiction.

As used herein, the term “acreage” refers to an area of land. The land area may be contiguous, but there is no requirement that the land area be contiguous.

As used herein, “metes and bounds description” refers to any text description of land or real property and from which the boundary of the land or real property can be determined or estimated. By way of non-limiting examples, the text description may conform to a government survey system, recorded plat survey system, recorded map survey system, a Torrens system, a lot and block survey system, a railroad survey, a township survey system, or the like. Non-limiting examples of metes and bounds descriptions of transacted acreage involved in certain oil and gas deals are provided herein.

As used herein, “non-topological geometry” refers to data, such as vector data, and associated metadata that does not explicitly store topological relationships between spatial features. For example, a non-topological polygon may be represented by one or more rings where each ring is a closed, non-self-intersecting loop. The vertices of a ring may maintain a consistent, clockwise order so that the area to the right when “walking” along the ring boundary, is inside the polygon, and the area to the left is outside the polygon.

### Indirect Sources of Acreage Information

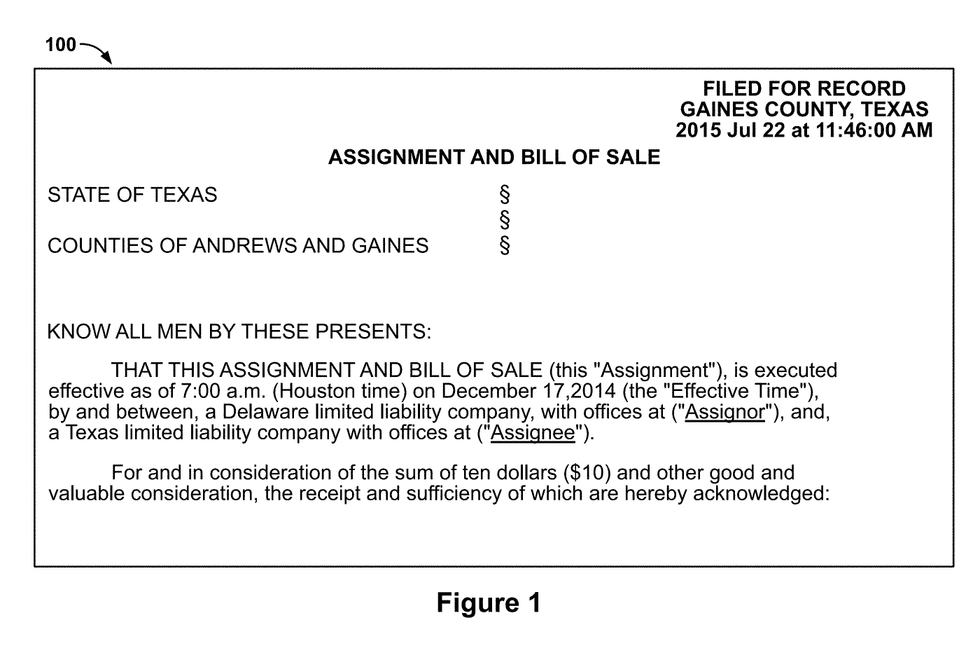

FIG. 1 shows a portion 100 of example state filing containing information on an oil and gas deal. In this example, the state filing was recorded in the Counties of Andrews and Gaines in the State of Texas. In the portion 100 shown in FIG. 1, some information has been redacted including: the names and addresses of the assignor and the assignee and the document identifier.

It should be understood that while examples of computer-implemented techniques for generating transacted acreage maps using indirect information sources are described herein in the context of oil and gas deals, it will be appreciated that the techniques may be applied in other contexts to generate transacted acreage maps. For example, the techniques may be applied in real estate or other contexts where state filings are made naming parties involved in transacting acreage and in which there is a description of the transacted acreage.

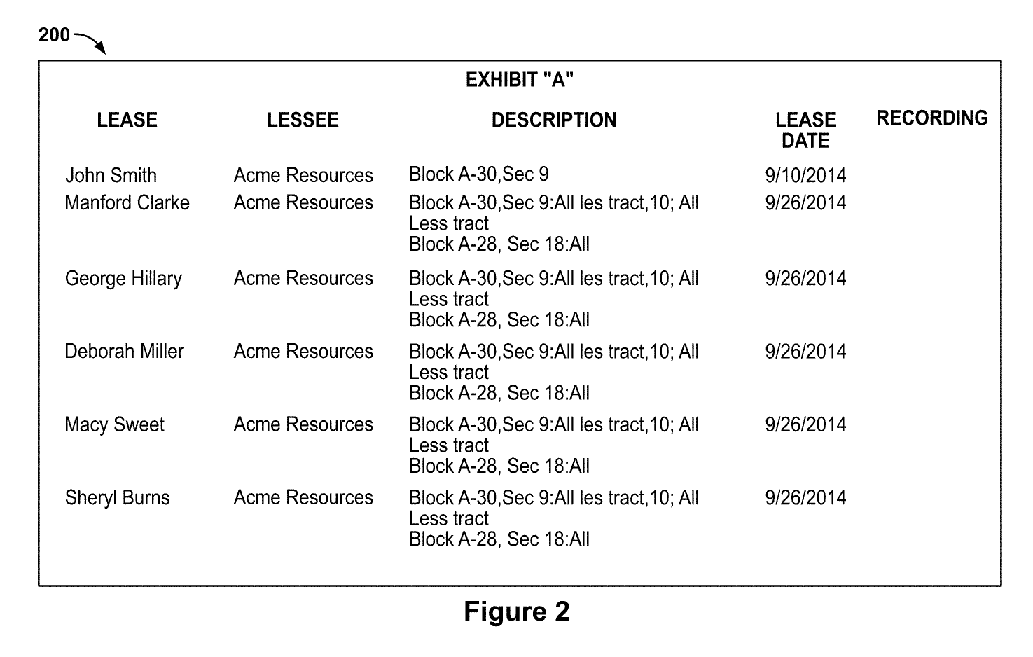

As mentioned, state filings pertaining to oil and gas deals may contain a disclosure of the acreage transacted as part of the deal. In the example deal depicted in FIG. 1, the assignor is assigning to the assignee oil and gas leases the assignor previously entered into or acquired from a previous lessee. The leases being assigned are listed in “Exhibit A” of the document as shown in the document portion 200 of FIG. 2. The document portion 200 shows that six leases are being assigned (the names of the lessor and lessee have been changed for purposes of this disclosure). The lessee of all six leases is the assignor of the indirectly sourced oil and gas deal listed in the portion 100 of the state filing depicted in FIG. 1. The document portion 200 includes a description of each lease. The lease description includes a metes and bounds description of the transacted acreage including block numbers and section numbers under a block/section-type land survey. From the lease descriptions of the document portion 200, it can be seen that the subject oil and gas deal involves leases for blocks/sections A-30/9 and A-28/18. In some implementations, the metes and bounds description may also describe a specific portion of a section to which the lease is limited. For example, A-28/18, NW4 may indicate that the lease covers the North-West quarter of Section 18 of Block A-28.

### Acreage Map

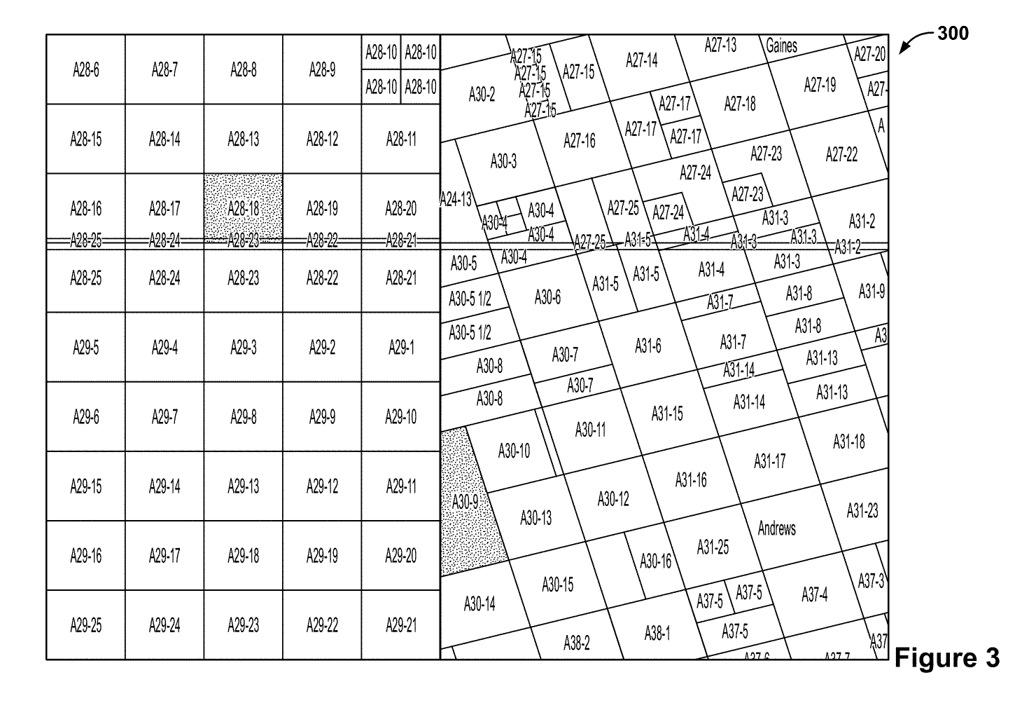

FIG. 3 depicts a state grid 300 highlighting the transacted acreage specified by the metes and bounds description of document portion 200 of FIG. 2. In particular, the block and section information, and any applicable section limiting information, of the lease descriptions is used to generate polygons defining the boundaries of the acreage that is the subject of the oil and gas deal. The polygons are then defined in a shapefile for use with a geospatial information system, such as an Environment Systems Resource Institute (ERSI) compatible geospatial information computer system. Geometry and geographic information about the polygons in the shapefile may be used to visually indicate the subject acreage of the oil and gas deal on a computer-generated geospatial map.

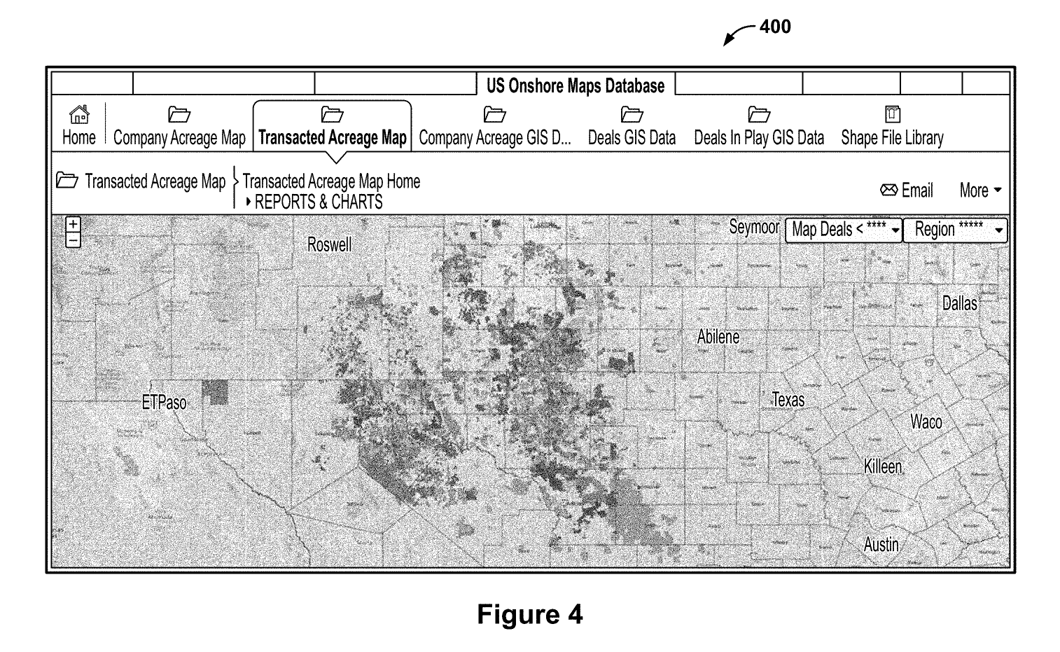

FIG. 4 provides a portion 400 of a screenshot of a computer-generated geospatial map with grayscale-filled polygons representing acreage that is the subject of various indirectly sourced oil and gas deals, according to some implementations. The location, shape, and size of the polygons may be defined in one or more shapefiles generated based on information on the oil and gas deals extracted from the county courthouse documents pertaining to the deals. Information on shapefiles is available on the Internet at /wiki/Shapefile in the wikipedia.org domain.

### System Environment

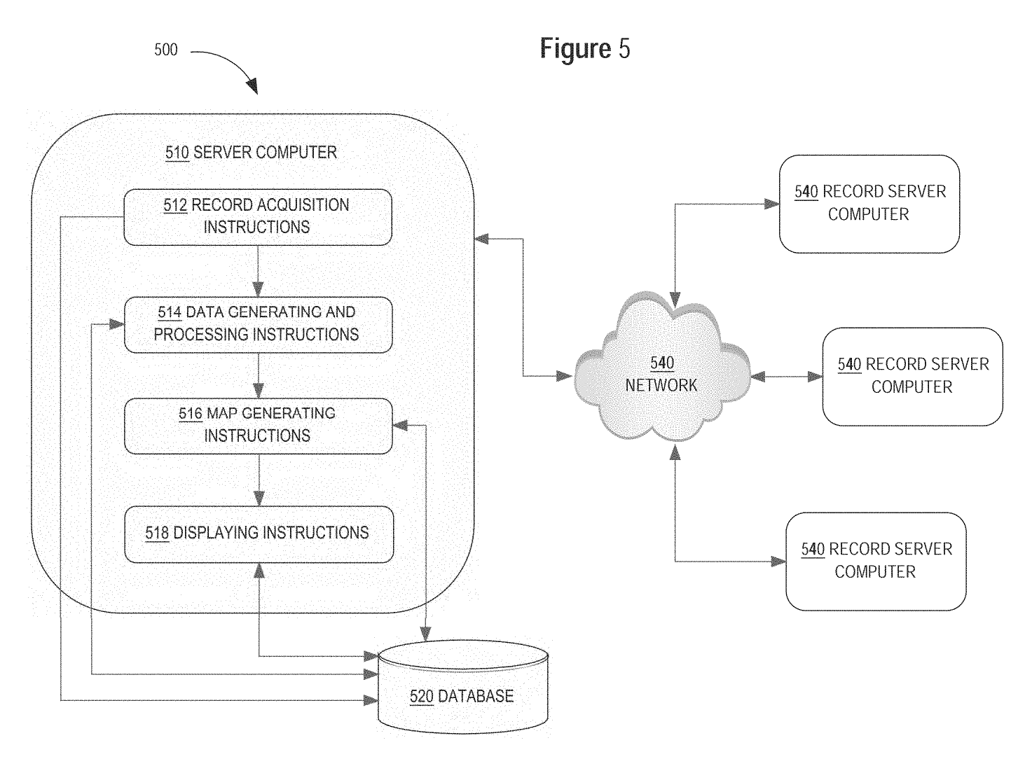

FIG. 5 is a system diagram that illustrates a computing system for generating a transacted acreage map according to some implementations. In the example of FIG. 5, a networked computer system 500 may facilitate the exchange of data between one or more computers, such as a server computer 510 and a state filing server computer 540. For example, the server computer 510 may be programmed with state filing acquisition instructions 512, which gather data such as state filings from one or more state filing server computers 540 by periodically checking for state filings pertaining to an “Assignment,” “Assignment and Bill of Sale,” or other like state filings.

In some implementations, the state filing acquisition instructions 512 may poll the state filing server computer 540 over a predetermined period of time. In some implementations, the state filing acquisition instructions 512 may crawl state filing web sites for new or recently recorded “Assignment,” “Assignment and Bill of Sale,” or other state filings. The state filing acquisition instructions 512 may also gather property data such property or land survey maps that may be used to track transactions and generate transaction profiles for particular companies. Data gathered by the state filing acquisition instructions 512 may be stored in a database 520 associated with the server computer 510.

In some implementations, a supervised machine learning process is trained on state filings known to disclose transacted acreage relevant to the oil and gas deals (e.g., positive examples) and also trained on state filings known not to disclose relevant transacted acreage (e.g., negative examples). For example, a binary classifier (e.g., a Naïve Bayes text document classifier) may be trained to classify an unseen state filing as relevant or not relevant to deals involving transacted acreage. In this regard, state filing acquisition instructions 512 may use the trained classifier to determine whether information from a given state filing should or should not be treated as relevant to a deal involving transacted acreage. For example, the trained classifier may determine that an obtained state filing is not relevant to a deal involving transacted acreage. As such, the state filing acquisition instructions 512 may not further process the obtained state filing (e.g., discard the document). Alternatively, the state filing may be stored in a separate database, or separate portion of database 520, designated for state filings for which there is low confidence the state filings pertain to transacted acreage. The low confidence state filings can be manually or automatically reviewed at a later time for classification errors. By using a trained classifier in this way, the state filing acquisition instructions 512 can effectively and automatically filter large numbers of state filings for those that are relevant to oil and gas deals involving transacted acreage.

The server computer 510 may also be programmed with data generating and processing instructions 514, which access the stored records from the database 520. The data generating and processing instructions 514 may parse the property transaction records, such as an “Assignment,” “Assignment and Bill of Sale,” or other like state filings, to generate property transaction data. In some implementations, the property transaction data may include the parties of the transaction, a description of the property, a date, or any other property transaction information.

The server computer 510 may also be programmed with a map generating instructions 516, which uses the property survey maps stored in the database 520, as well as the property information generated using the data generating and processing instructions 514 to generate a plurality of polygons representing one or more properties involved in the particular transaction record. The polygons are subsequently used to generate a transaction map of the property, which may be stored in the database 520.

In some implementations, machine learning clustering algorithms may be used for geospatial data to generate polygonal datasets that represent the properties involved in a transaction record. For example, a clustering analysis may be implemented such that data generated using the data generating and processing instructions 514, as well as property survey map data stored in the database 520, are used to generate polygons representing a property. In an embodiment, the clustering algorithms may be used to identify, for example, all transactions involving certain parties and generate color-coded polygons representing each property involving each of the parties. In this example, a map of all the property transaction involving each of the parties may be generated and subsequently displayed. Therefore, machine learning cluster analyses may be used to efficiently and automatically generate polygons representing properties and generate a transaction map of the property.

The server computer 510 may also be programmed with displaying instructions 518 that displays the transaction map of the property through a GUI. The GUI may be web-based. That is, the GUI may be displayed in a conventional web browser application, thereby allowing users to access the database 520 without having to download and install special dedicated client software for accessing the database 502. Other types of GUIs are also possible including dedicated client applications that drive the GUI such as a mobile device application or a desktop application.

Network 530 broadly represents a combination of one or more local area networks, wide area networks, global interconnected internetworks, such as the public internet, or a combination thereof. Each such network may use or execute stored programs that implement internetworking protocols according to standards such as the Open Systems Interconnect (OSI) multi-layer networking model, including but not limited to TCP or UDP, IP, HTTP, and so forth. All computers described herein may be configured to connect to the network 130 and the disclosure presumes that all elements of FIG. 5 are communicatively coupled via network 530.

While each of the components listed above is illustrated as if located on a single computer, one or more of the components listed above may be part of and/or executed on different computers. For example, data repository 520 may be located on the same or a separate computer from another data repository 520. As another example, data repository 520 may be storage drives coupled to an enterprise server.

A “computer” may be one or more physical computers, virtual computers, and/or computing devices. As an example, a computer may be one or more server computers, cloud based computers, cloud-based cluster of computers, virtual machine instances or virtual machine computing elements such as virtual processors, storage and memory, data centers, storage devices, desktop computers, laptop computers, mobile devices, and/or any other special-purpose computing devices. Any reference to “a computer” herein may mean one or more computers, unless expressly stated otherwise. The instructions identified above are executable instructions and may comprise one or more executable files or programs that have been compiled or otherwise built based upon source code prepared in JAVA, C++, OBJECTIVE-C or any other suitable programming environment.

### Example Process

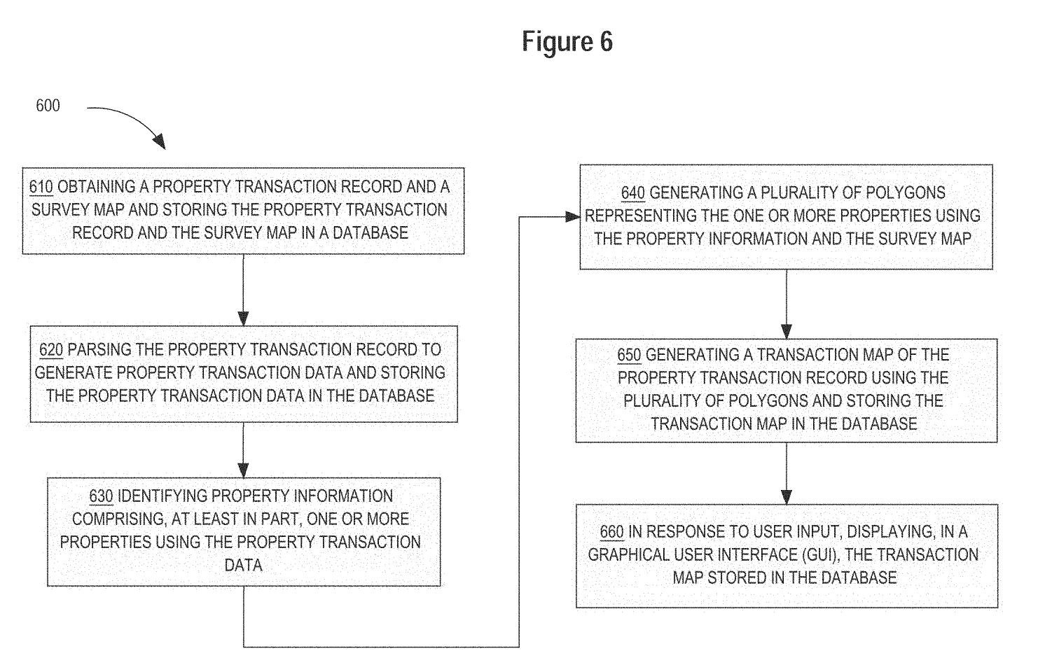

FIG. 6 is a flowchart that illustrates a method or algorithm for creating and modifying digital maps and displaying them in a graphical user interface, in an example embodiment.

At step 610, the server computer 510 obtains a property transaction record and a survey map and stores the property transaction records and the survey map in the database 520. Specifically, the record acquisition instructions 512 may access a web site and/or database related to the state filing server computer 540 and search for state filings. The website may be a court website for a particular state, for example, that enables access to one or more court “Assignments,” “Assignment and Bill of Sales,” or other like state filings. The record acquisition instructions 512 may download one or more state filings related to an oil and gas deal, in some implementations. FIG. 1 is just one example of such a state filing. The example of FIG. 1 illustrates an “Assignment and Bill of Sale” for the state of Texas where two parties agree to an assignment.

At step 620, the server computer 510 parses the state filing to generate property transaction data. For example, the data generating and processing instructions 514 may parse through the “Assignment and Bill of Sale” to identify the assignor and assignee, lessor and lessee, or buyer and seller, of the transaction. Subsequently, a new entry for a deal may be created in the database of deals if this deal had not already been identified from other public sources.

Additional information related to the deal may also be extracted from the court documents that provide some qualifications on the acreage transacted. These qualifications include whether rights to only specific depths below the surface have been sold, whether all or partial working interests in the leases have been sold and whether there are any retained interests that are being excluded by the seller from the transaction. This extraction of additional information from the court documents may be done manually or using computers and machine learning algorithms.

At step 630, the server computer 510 identifies property information comprising, at least in part, one or more properties using the property transaction data. In an example embodiment, the data generating and processing instructions 514 may identify the information on leases transacted in the particular deal, which may be provided in Exhibit A of a court document, for example.

FIG. 2 is an example county courthouse document containing information on land blocks/sections involved in the oil and gas deal depicted in FIG. 1, in an example embodiment. In the example of FIG. 2, “Exhibit A” of an “Assignment and Bill of Sale” features a list of six parties involved in assignments under the “Lease” column. Each of the six parties have leased property that is described in the “Description” column to the lessee featured in the “Lessee” column. “Exhibit A” also features the date of the lease for each of the six assignments. While the example information of FIG. 2 on property blocks/sections is for the state of Texas, the information may correspond to any state or any county. Courthouse documents filed with other counties may feature any information pertaining to township, range, and blocks/sections. This information may be manually entered or extracted using computers, optical character recognition software, and machine learning algorithms.

At step 640, based on the information available on leases captured, a plurality of polygons is created using the survey map or state grid. As used herein, a survey map refers generally to a map or metadata about a map that defines the boundaries of various land surface features, such as a land and lease survey map or metadata about such a map that defines the boundaries of various land leases within a city, county, state, or other geographic jurisdiction. In some implementations, acreage information extracted from a state filing is mapped to geospatial information (e.g., geographic coordinates and/or vectors) using a geospatial database such as land survey database or a state grid database, such as a railroad grid or the like. The geospatial information is then mapped to non-topological geometry that define the shape and outline of one or more polygons in a geospatial shapefile for a particular deal. For example, at step 650, a transaction map of the property transaction record is generated using the plurality of polygons. FIG. 3 is a generated and compiled transaction map, in an example embodiment. The transaction map may be stored in the database 520.

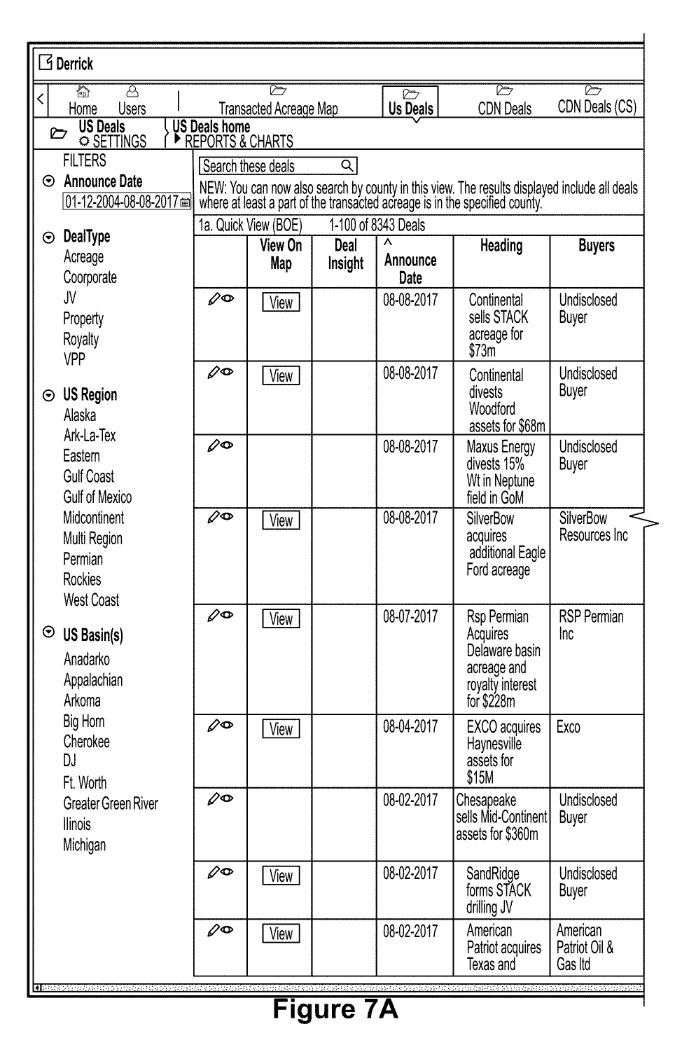

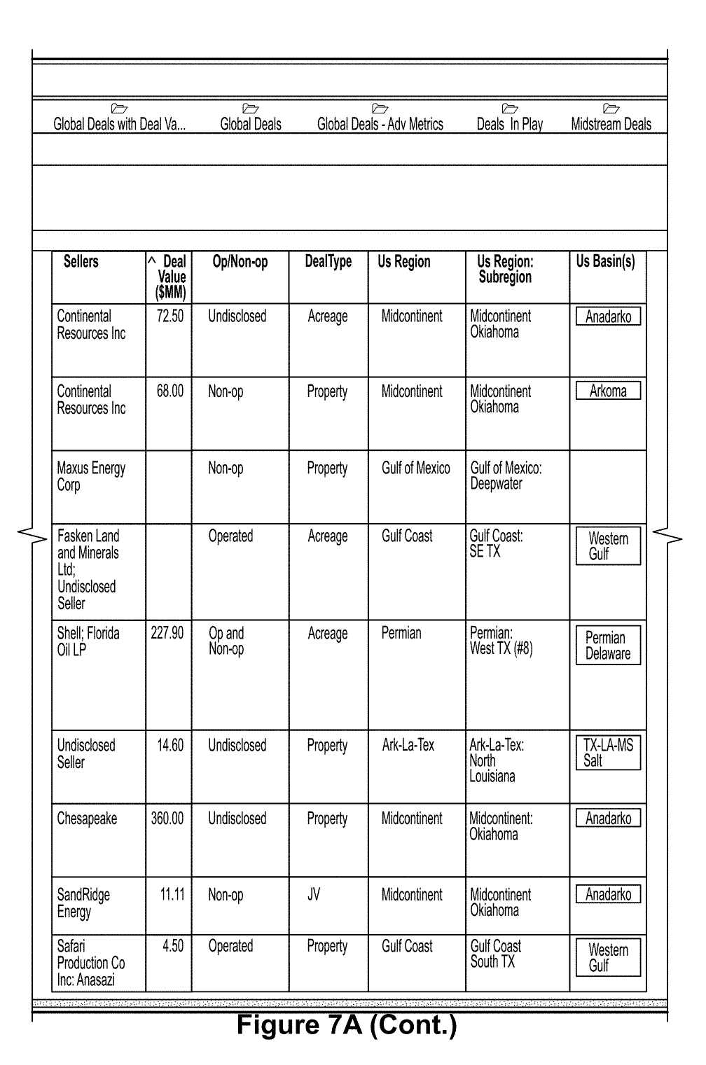

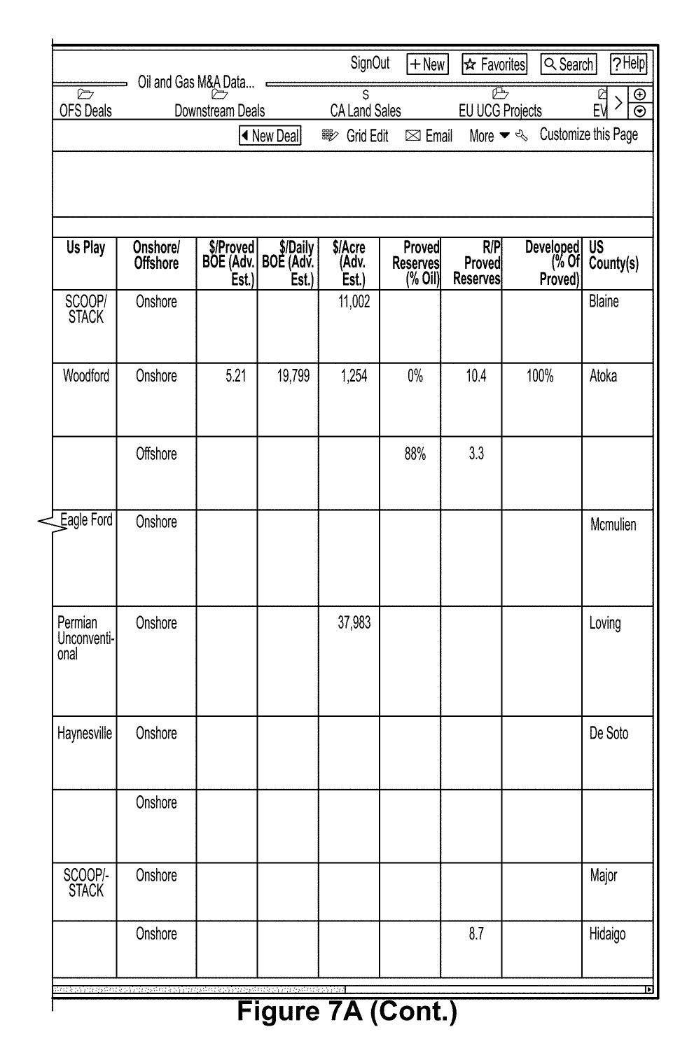

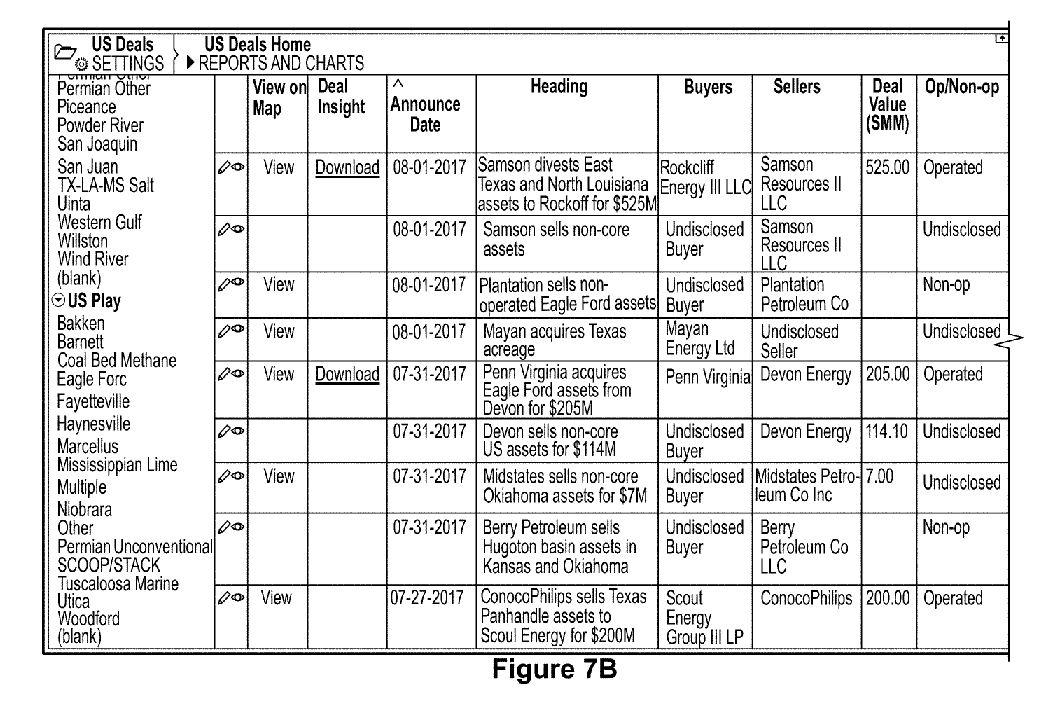

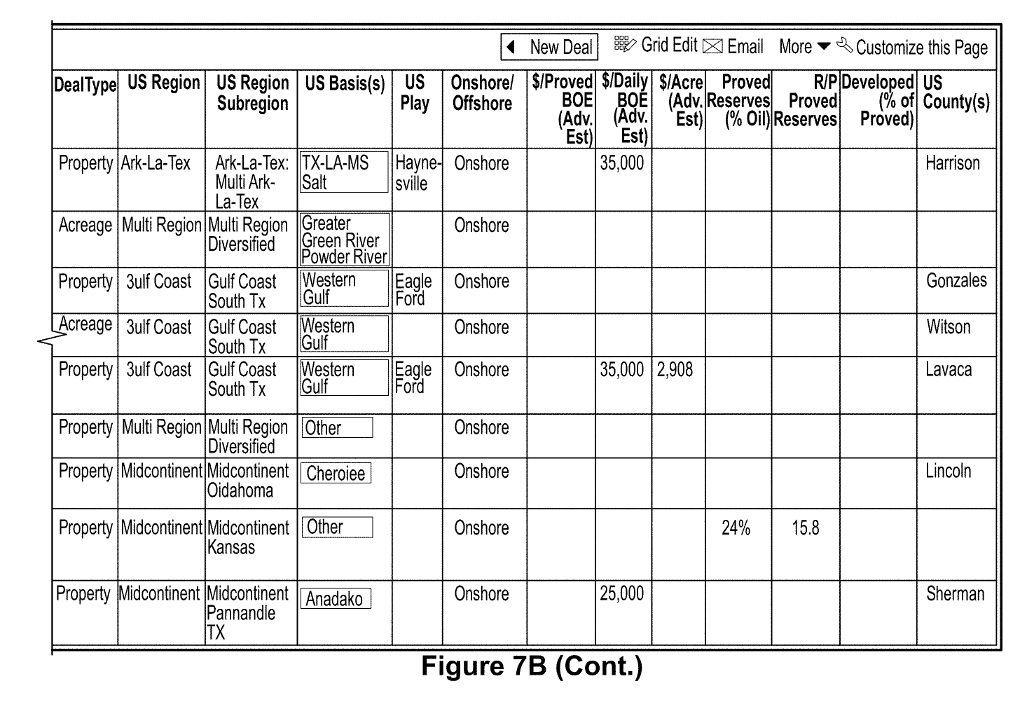

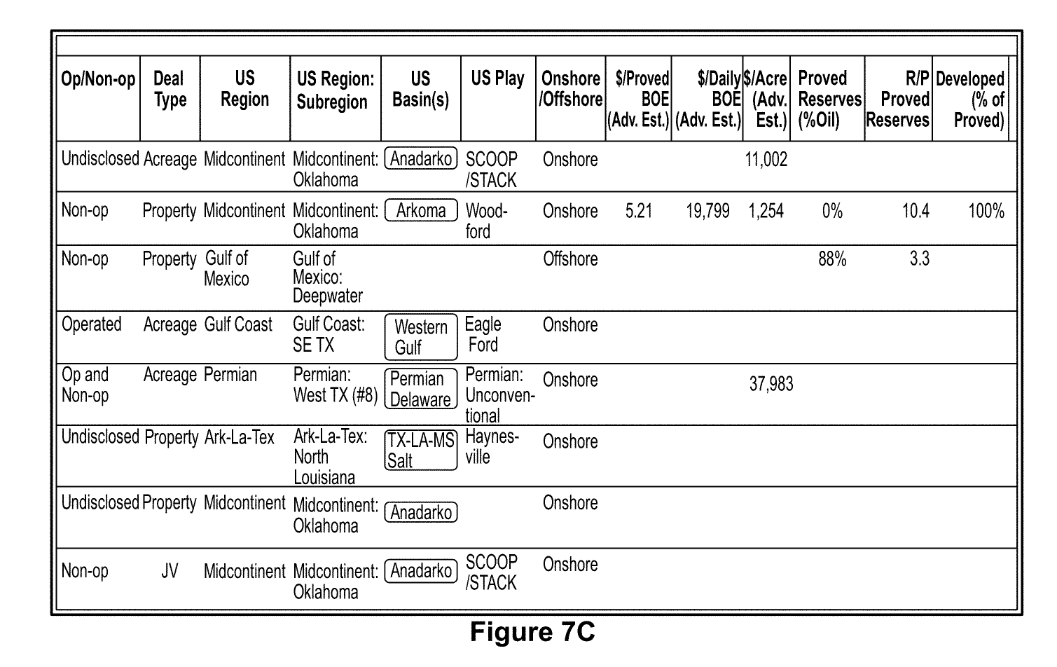

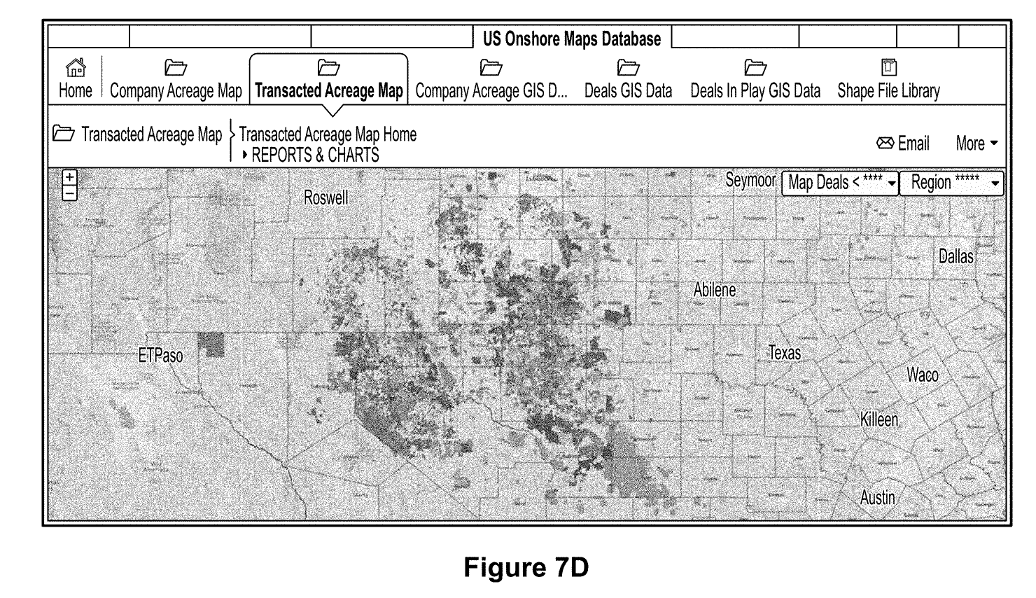

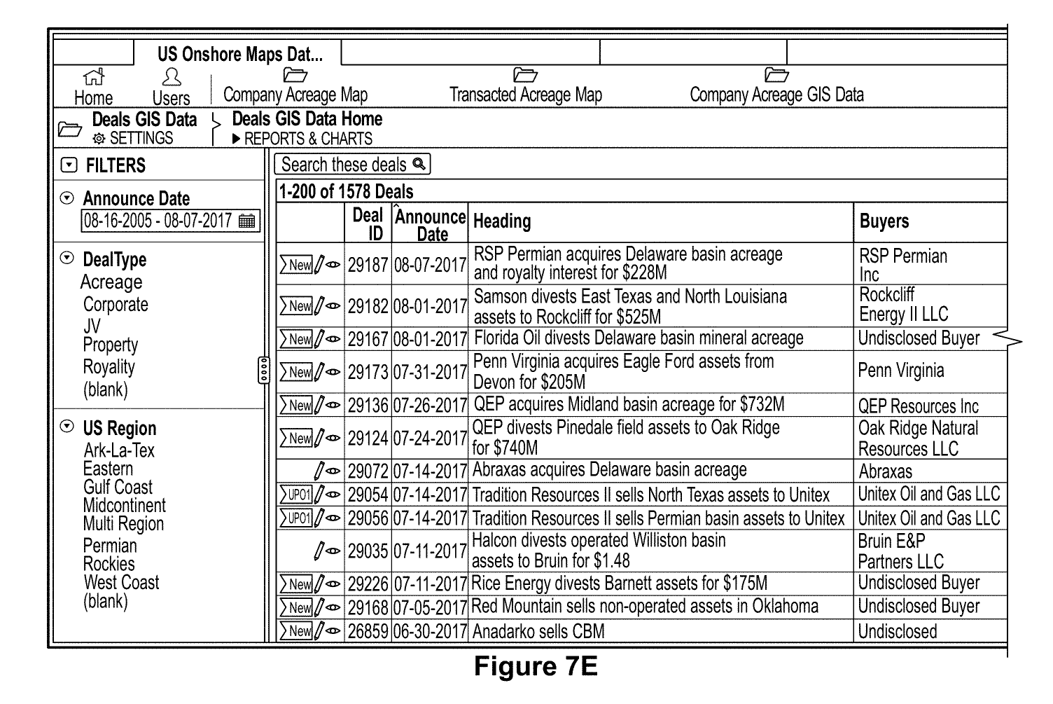

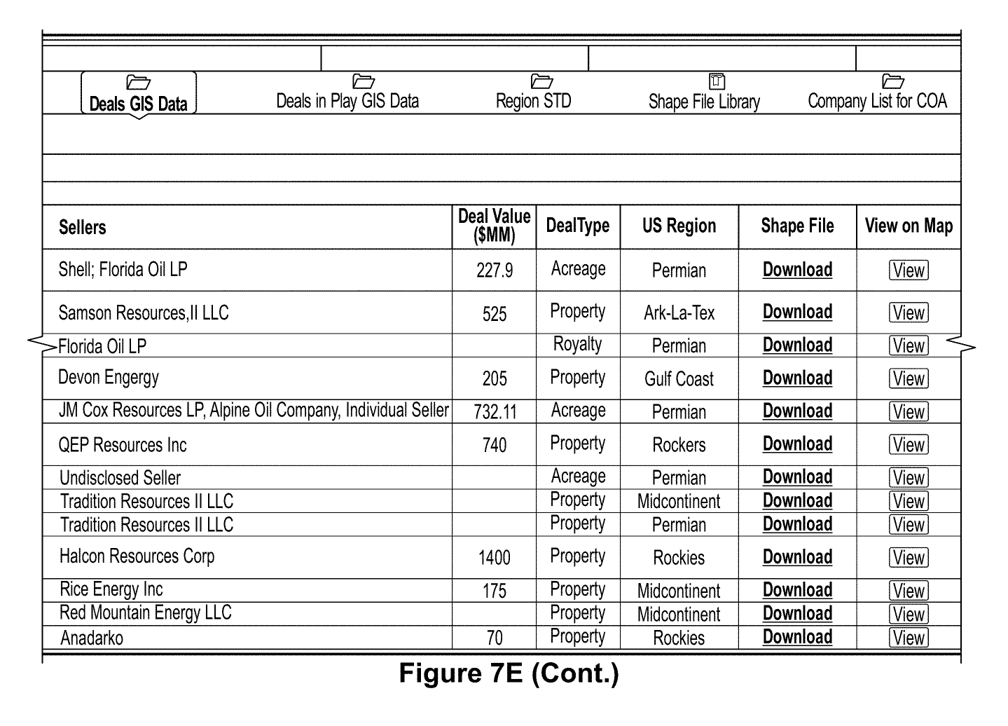

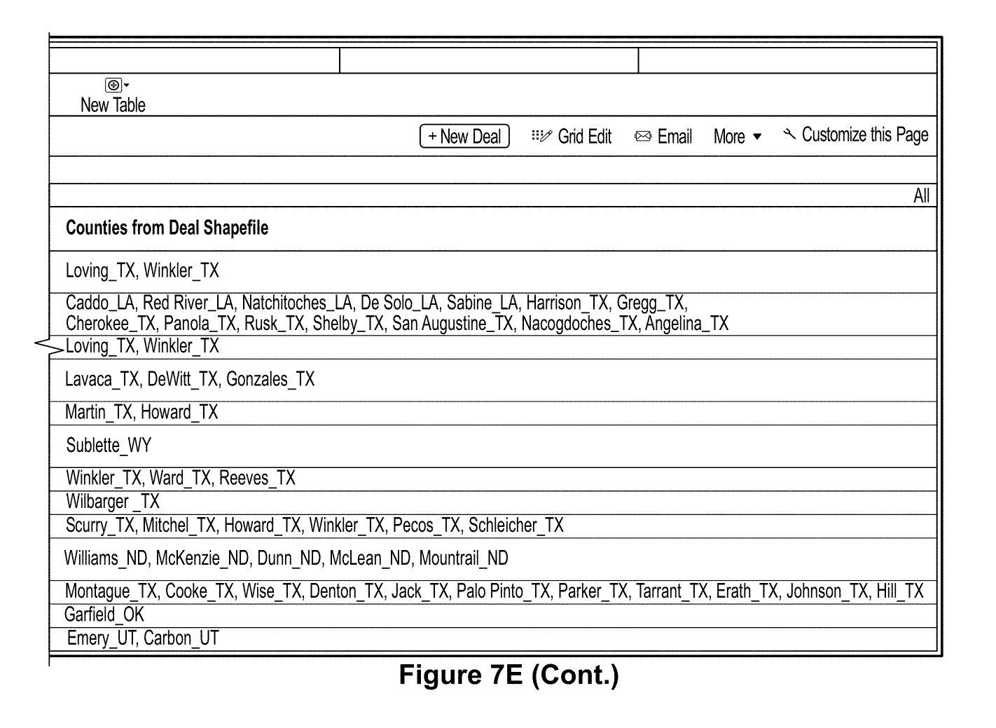

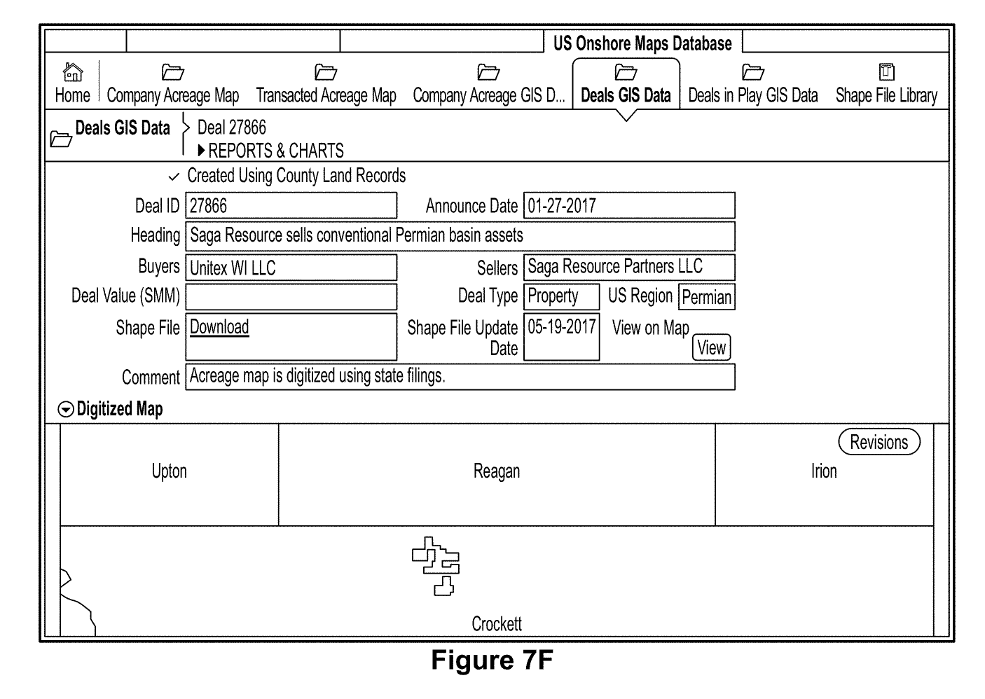

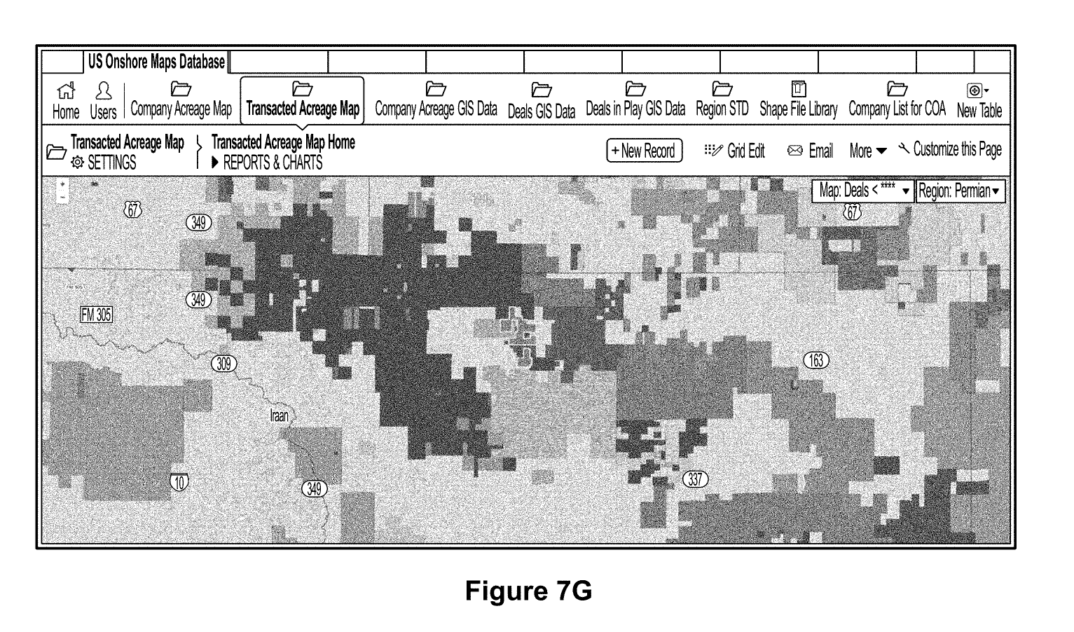

At step 660, in response to user input, the server computer 510 may display, in a GUI, the transaction map stored in the database 520. FIG. 7A is a graphical user interface, in an example embodiment. The GUI may contain improved search filters unique to the oil and gas industry such as searching for companies or deals in a particular basin or searching for deals that are either oil-weighted or gas-weighted. Users can view the deal maps and the company acreage maps on a map interface. The map interface may also have data on oil and gas wells, permits, completion and production from other sources such the Texas Railroad Commission, the Colorado Oil and Gas Conservation Commission and other State regulatory authorities. A user will be able to draw unique insights by using the maps from court documents with these other publicly available data sets. In the example of FIG. 7A, a user may access a Mergers & Acquisitions (M&A) database featuring a U.S. Deals tab and filters unique to the oil and gas industry, such as the U.S. Basin(s) or U.S. Play filters.

The process depicted in FIG. 6 as described above pertains to creating an acreage map for a particular oil and gas deal specified in an obtained property transaction record. It should be understood that the polygons of multiple acreage maps can be aggregated to produce an acreage map for multiple oil and gas deals corresponding to multiple obtained property transaction records such as all the oil and gas deals where a particular company X is the specified assignee, lessee, or lessor of all the deals.

### Example User Interfaces

FIGS. 7A-7G are various screenshots of graphical user interfaces generated based on or associated with some implementations of generating a transacted acreage map for an oil and gas deal using indirect sources.

As explained above, state filings such as “Assignment” or “Assignment and Bill of Sale” state filings may be used to indirectly source information (e.g., transacted acreage information) on oil and gas deals. Information about such deals may be stored a database, which may combine the indirectly sourced information with directly sourced information (e.g., press releases) about the deals.

FIG. 7A is a screenshot of a graphical user interface generated based on information in a database that stores indirectly and directly sourced information about oil and gas deals. In this example, the user has selected oil and gas merger and acquisition deals in the United States that were announced during the period beginning Jan. 12, 2004 and ending Aug. 8, 2017. The deals are listed in tabular form with one row per deal in descending order of announce date.

Selectable filters are available on the left-hand side of the user interface that are specific to “US Deals” such as “Deal Type” filters, “US Region” filters, and “US Basin” filters, etc., for constraining the set of listed deals to only those that match the selected filter.

FIG. 7B is a screenshot of a graphical user interface based on the graphical user interface of FIG. 7A after the user has scrolled down to view additional selectable filters that are available in the left-hand user interface pane including a “US Play” filter.

FIG. 7C is a screenshot of a graphical user interface related to the graphical user interfaces of FIGS. 7B and 7C that show various column headings of the deals table shown in FIGS. 7B and 7C. In some implementations, a user may select a column heading in a graphical user interface with appropriate user input to sort the listed deals by the values in the selected column, either in descending or ascending order.

FIG. 7D is a screenshot of a graphical user interface that contains a transacted acreage map generated based at least in part on acreage information extracted from state filings pertaining to oil and gas deals. That is, some of the polygons of the map is generated using the extracted acreage information. The map of FIG. 7D shows all deals for the selected “Permian basin” in the database for which transacted acreage information is available.

FIG. 7E is a screenshot of a graphical user interface that lists United States onshore deals announced between Aug. 16, 2005 and Aug. 7, 2017 for which geographic information systems data is available. Selectable filters are available on the left-hand side of the user interface that are specific to deals in the “US Onshore Maps Database” such as “Deal Type” filters, “US Region” filters, and “US Basin” filters, etc., for constraining the set of listed deals to only those that match the selected filter.

FIG. 7F is a screenshot of a graphical user interface that provides detailed information on a particular deal selected in the graphical user interface of FIG. 7E. In this example, the detailed information includes a map of the acreage transacted in the deal generated based on state filings pertaining to the deal. FIG. 7G is a screenshot of a graphical user interface that shows the acreage of the particular deal in relation to the acreage of other deals after selection of the “View on Map” option available in the graphical user interface of FIG. 7F. The acreage of the particular deal is highlighted in the map with a yellow outline.

### Another Example State Filing

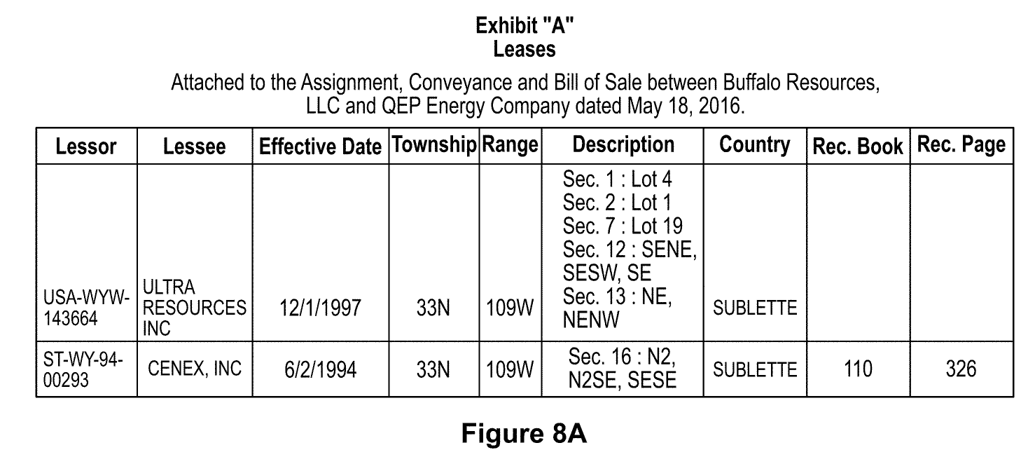

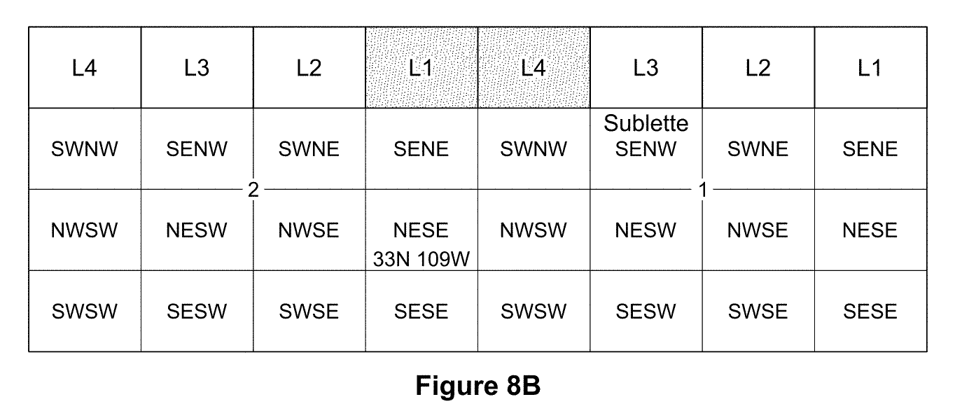

FIG. 8A is a portion of another state filing based on which a transacted acreage map is generated, according to some implementations. The state filing in the example of FIG. 8A is a filing in Sublette County in the State of Wyoming. The state filing pertains to an assignment of oil and gas interest between a buyer and a seller. The state filing contains the following metes and bounds description of the acreage transacted in the deal: Township 33N, Range 109W, Sec 1: Lot 4, Sec 2: Lot 1, Sec 7: Lot 19, Sec 12: SENE, SESW, SE, Sec 13: NE, NENW; and Township 33N, Range 109W, Sec 16: N2, N2SE, SESE.

For the State of Wyoming, the metes and bounds description in the state filing may be mapped to Wyoming Township-Range, Section and Quarter grids and associated geospatial information. For example, FIG. 8B shows the Township 33N, Range 109W grid. Within the grid, polygons (filled in yellow) outline the portions of the sections of the some of the acreage transacted as described in the state filing. In particular, the Lot 4 of Section 1 and Lot 1 of Section 2 are highlighted.

### Implementing Mechanisms

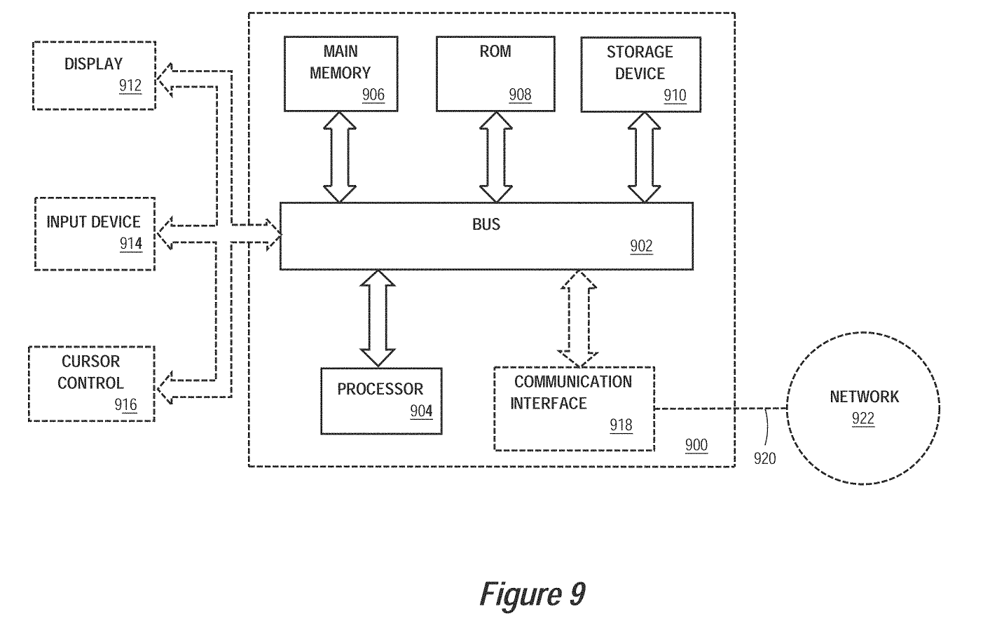

The present disclosure, in some embodiments, is implemented using a computing system comprising one or more processors and storage media. The one or more processors and memory may be provided by one or more hardware machines. FIG. 9 illustrates an example of a basic hardware machine 900 that may be used in some implementations. Hardware machine 900 and its hardware components, including their connections, relationships, and functions, is meant to be exemplary only, and not meant to limit implementations of the present disclosure. Other hardware machines suitable for implementing the present disclosure may have different components, including components with different connections, relationships, and functions. Hardware machine 900 includes a bus 902 or other communication mechanism for addressing a main memory 906 and for transferring data between and among the various components of hardware machine 900.

Hardware machine 900 also includes a processor 904 coupled with bus 902 for processing information. Processor 904 may be a general-purpose microprocessor, a system on a chip (SoC), or another hardware processor.

Main memory 906, such as a random-access memory (RAM) or other dynamic storage device, is coupled to bus 902 for storing information and software instructions to be executed by processor 904. Main memory 906 also may be used for storing temporary variables or other intermediate information during execution of software instructions to be executed by processor 904.

Software instructions, when stored in storage media accessible to processor 904, render hardware machine 900 into a special-purpose computing machine that is customized to perform the operations specified in the software instructions. The terms “software,” “software instructions,” “computer program,” “computer-executable instructions,” and “processor executable instructions” are to be broadly construed to cover any machine-readable information, whether or not human-readable, for instructing a machine to perform specific operations, and including, but not limited to, application software, desktop applications, scripts, binaries, operating systems, device drivers, boot loaders, shells, utilities, system software, JAVASCRIPT, web pages, web applications, mobile applications, plugins, embedded software, microcode, compilers, debuggers, interpreters, virtual machines, linkers, and text editors.

Hardware machine 900 includes a read-only memory (ROM) 908 or other static storage device coupled to bus 902 for storing static information and software instructions for a processor 904.

A mass storage device 910 is coupled to bus 902 for persistently storing information and software instructions on fixed or removable media, such as magnetic, optical, solid-state, magnetic-optical, flash memory, or any other available mass storage technology. The mass storage may be shared on a network, or it may be dedicated mass storage. Mass storage device 910 may store a body of program and data for directing operation of hardware machine 900, including an operating system, user application programs, driver, and other support files, as well as other data files of all sorts.

Hardware machine 900 may be coupled via bus 902 to a display 912, such as a liquid crystal display (LCD) or other electronic visual display, for displaying information to a computer user. A touch sensitive surface incorporating touch detection technology (e.g., resistive, capacitive, etc.) may be incorporated with display 912 to form a touch sensitive display for communicating touch gesture (e.g., finger or stylus) input to processor 904.

An input device 914 may be coupled to bus 902 for communicating information and command selections to processor 904. Input device 914 may include alphanumeric and other keys. Input device 914 may include one or more physical buttons or switches such as, for example, a power (on/off) button, a “home” button, volume control buttons, or the like.

A cursor control 916, such as a mouse, a trackball, touchpad, touch-sensitive surface, or cursor direction keys for communicating direction information and command selections to processor 904 and for controlling cursor movement on display 912, may be coupled to bus 902. Cursor control 916 may have two degrees of freedom in two axes, a first axis (e.g., x) and a second axis (e.g., y), that allows the device to specify positions in a plane. Cursor control 916 may have more degrees of freedom with a third axis (e.g., z). For example, cursor control 916 may have three translational degrees of freedom (e.g., surge, heave, and sway) in three perpendicular axes, that allows the device to specify position in the three axes. Cursor control 916 may have three rotational degrees of freedom (e.g., pitch, yaw, roll) about three perpendicular axes, that allows the device to specify an orientation about the three axes.

While one or more of display 912, input device 914, and cursor control 916 may be external components (e.g., peripheral devices) of hardware machine 900, some or all of display 912, input device 914, and cursor control 916 may be integrated as part of the form factor of hardware machine 900.

A function or operation of the present disclosure may be performed by hardware machine 900 in response to processor 904 executing one or more programs of software instructions contained in main memory 906. Such software instructions may be read into main memory 906 from another storage medium, such as a storage device 910. Execution of the software instructions contained in main memory 906 cause processor 904 to perform the function or operation.

While a function or operation of the present disclosure may be implemented entirely with software instructions, hard-wired or programmable circuitry of hardware machine 900 (e.g., an ASIC, a FPGA, or the like) may be used in place of or in combination with software instructions to perform the function or operation.

The term “storage media” as used herein refers to any non-transitory media that store data and/or software instructions that cause a hardware machine to operate in a specific fashion. Such storage media may comprise non-volatile media and/or volatile media. Non-volatile media includes, for example, non-volatile random access memory (NVRAM), flash memory, optical disks, magnetic disks, or solid-state drives, such as storage device 910. Volatile media includes dynamic memory, such as main memory 906. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more software instructions to processor 904 for execution. For example, the software instructions may initially be carried on a magnetic disk or solid-state drive of a remote computer. The remote computer can load the software instructions into its dynamic memory and send the software instructions over a data communications network. Hardware machine 900 can receive the data over the data communications network and appropriate circuitry can place the data on bus 902. Bus 902 carries the data to main memory 906, from which processor 904 retrieves and executes the software instructions. The software instructions received by main memory 906 may optionally be stored on storage device 910 either before or after execution by processor 904. Hardware machine 900 may include a communication interface 918 coupled to bus 902.

Communication interface 918 provides a two-way data communication coupling to a wired or wireless network link 920 that connects hardware machine 900 to a data communications network 922 (e.g., a local area network (LAN), a wide area network (WAN), a wireless local area network (WLAN), a metropolitan area network (MAN), a storage area network (SAN), etc.). Network link 920 provides data communication through network 922 to one or more other networked devices.

Communication interface 918 may send and receive electrical, electromagnetic, or optical signals that carry digital data streams representing various types of information. For example, communication interface 918 may be implemented by a wired network interface card, a wireless network interface card with an integrated radio antenna, or a modem.

Network link 920 may provide a connection through network 922 to a host computer or to data equipment operated by an Internet Service Provider (ISP). The ISP may in turn provide data communication services through the world-wide packet data communication network now commonly referred to as the “Internet”. Network 922 and Internet use electrical, electromagnetic or optical signals that carry digital data streams. The signals through the various networks and the signals on network link 920 and through communication interface 918, which carry the digital data to and from hardware machine 900, are example forms of transmission media. Hardware machine 900 can send messages and receive data, including program code, through network 922, network link 920, and communication interface 918. In the Internet example, a server might transmit a requested code for an application program through Internet, ISP, and network 922 and communication interface 918.

The received code may be executed by processor 904 as it is received, and/or stored in storage device 910, or other non-volatile storage for later execution.

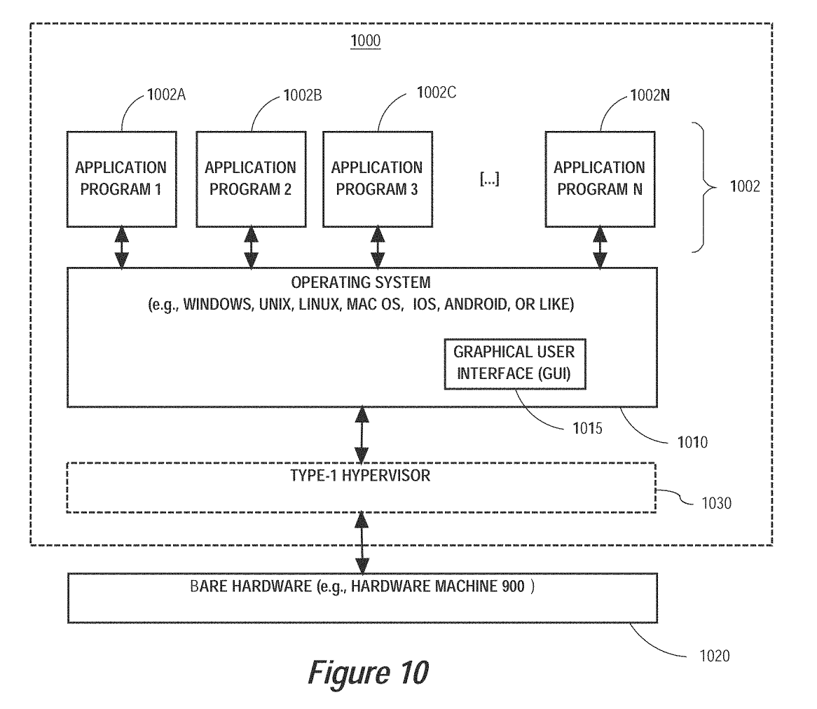

FIG. 10 illustrates basic software system 1000 that may be employed for controlling the operation of hardware machine 900 of FIG. 9, according to an embodiment of the present disclosure. Software system 1000 and its software components, including their connections, relationships, and functions, is meant to be exemplary only, and not meant to limit implementations of the present disclosure. Other software systems suitable for implementing the present disclosure may have different components, including components with different connections, relationships, and functions.

Software system 1000 is provided for directing the operation of hardware machine 900. Software system 1000 may be stored in system memory (RAM) 906 and on fixed storage (e.g., hard disk or flash memory) 910.

Software system 1000 includes a kernel or operating system (OS) 1010. OS 1010 manages low-level aspects of computer operation, including managing execution of processes, memory allocation, file input and output (I/O), and device I/O.

Software system 1000 includes one or more application programs, represented as 1002A, 1002B, 1002C . . . 1002N, that may be “loaded” (e.g., transferred from fixed storage 910 into memory 906) for execution by hardware machine 900. The applications or other software intended for use on hardware machine 900 may also be stored as a set of downloadable computer-executable instructions, for example, for downloading and installation from an Internet location (e.g., a Web server, an app store, or other online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. GUI 1015 also serves to display the results of operation from the OS 1010 and applications 1002, whereupon the user may supply additional inputs or terminate the session (e.g., log off).

Software system 1000 can execute directly on bare hardware 1020 (e.g., machine 900). Alternatively, a “Type-1” hypervisor 1030 may be interposed between the bare hardware 1020 and OS 1010 as part of software system 1000. Hypervisor 1030 acts as a software “cushion” or virtualization layer between the OS 1010 and bare hardware 1020. Hypervisor 1030 instantiates and runs one or more virtual machine instances. Each virtual machine instance comprises a “guest” operating system, such as OS 1010, and one or more applications, such as applications 1002, designed to execute on the guest operating system. Hypervisor 1030 presents the guest operating systems with a virtual operating platform and manages the execution of the guest operating systems.

Hypervisor 1030 may allow a guest operating system to run as if it is running on bare hardware 1020 directly. In this case, the guest operating system as configured to execute on bare hardware 1020 can also execute on hypervisor 1030. In other words, hypervisor 1030 may provide full hardware virtualization to the guest operating system. Alternatively, hypervisor 1030 may provide para-virtualization to the guest operating system. In this case, the guest operating system is “aware” that it executes on hypervisor 1030 and is specially designed or configured to execute on hypervisor 1030.

In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the embodiments, and what is intended by the applicants to be the scope of the embodiments, is the scope of the set of claims that issue from this application, in the specific form in which such claims issue, including any subsequent correction.

What is claimed is:

1. A computer-implemented method performed by a computing system comprising one or more processors and storage media, the storage media storing one or more programs executed by the one or more processors to perform the method, the method comprising:
obtaining a property transaction record and a survey map and storing the property transaction record and the survey map in a database;
parsing the property transaction record to generate property transaction data and storing the property transaction data in the database;
identifying property information comprising, at least in part, one or more properties using the property transaction data;
generating a plurality of polygons representing the one or more properties using the property information and the survey map;
generating a transaction map of the property transaction record using the plurality of polygons and storing the transaction map in the database; and
in response to user input, displaying, in a graphical user interface (GUI), the transaction map stored in the database.

2. The computer-implemented method of claim 1, wherein obtaining the property transaction record and the survey map comprises:
accessing a state court website that references the property transaction record and the survey map; and
downloading the property transaction record and the survey map through the state court website.

3. The computer-implemented method of claim 1, further comprising identifying, through the parsing, an identification of two or more parties to a property transaction associated with the generated property transaction data.

4. The computer-implemented method of claim 1, wherein generating a plurality of polygons representing the one or more properties using the property information and the survey map comprises:
extracting acreage information from the generated property transaction data;
mapping the extracted acreage information to a geospatial database associated with the generated property transaction data; and
mapping geospatial information from the geospatial database to a non-topological geometry that defines the shape and outline of each of the plurality of polygons.

5. The computer-implemented method of claim 4, wherein the geospatial information comprises data associated with at least one of geographic coordinates or vectors.

6. A data processing system, comprising:
one or more hardware processors;
one or more memory modules communicably coupled to the one or more hardware processors; and
an execution system operable on the one or more hardware processors to perform operations comprising:
obtaining a property transaction record and a survey map and storing the property transaction record and the survey map in a database;
parsing the property transaction record to generate property transaction data and storing the property transaction data in a structured database stored on the one or more memory modules;
identifying property information comprising, at least in part, one or more properties using the property transaction data;
generating a plurality of polygons representing the one or more properties using the property information and the survey map;
generating a transaction map of the property transaction record using the plurality of polygons and storing the transaction map in the structured database; and
in response to user input, displaying, in a graphical user interface (GUI), the transaction map stored in the database.

7. The data processing system of claim 6, wherein the operation of obtaining the property transaction record and the survey map comprises:
accessing a state court website that references the property transaction record and the survey map; and
downloading the property transaction record and the survey map through the state court website.

8. The data processing system of claim 6, wherein the execution system is operable on the one or more hardware processors to perform operations further comprising identifying, through the parsing, an identification of two or more parties to a property transaction associated with the generated property transaction data.

9. The data processing system of claim 6, wherein the operation of generating a plurality of polygons representing the one or more properties using the property information and the survey map comprises:
extracting acreage information from the generated property transaction data;
mapping the extracted acreage information to a geospatial database associated with the generated property transaction data; and
mapping geospatial information from the geospatial database to a non-topological geometry that defines the shape and outline of each of the plurality of polygons.

10. The data processing system of claim 9, wherein the geospatial information comprises data associated with at least one of geographic coordinates or vectors.

11. A computer-method performed by a computing system comprising one or more processors and storage media, the storage media storing one or more programs executed by the one or more processors to perform the method, the method comprising:
obtaining a digital version of a state filing pertaining to a deal involving transacted acreage;
obtaining metes and bounds description of the transacted acreage from the digital version;
using the metes and bounds description to generate a geographic information system shapefile specifying non-topological geometry of the transacted acreage; and
using the shapefile to cause the geographic information system to display a map that visually indicates at least boundaries of the transacted acreage as one or more polygons overlaid on the map display.

12. The computer-implemented method of claim 11, wherein the state filing comprises an assignment, or an assignment and bill of sale.

13. The computer-implemented method of claim 11, wherein obtaining the digital version of the state filing is based, at least in part, on automatically downloading the digital version of the state filing from a website.

14. The computer-implemented method of claim 11, wherein obtaining the digital version of the state filing is based, at least in part, on using a machine learning binary classifier to classify the state filing is either a) relevant or b) not relevant to a deal involving transacted acreage.

15. The computer-implemented method of claim 11, wherein the digital version of the state filing is text based, and
processing the digital version of the state filing is based, at least in part, on parsing text of the digital version of the state filing to extract from the state filing the metes and bounds description.

16. The computer-implemented method of claim 15, further comprising performing optical character recognition on another digital version of the state filing to produce the text-based digital version of the state filing.

17. The computer-implemented method of claim 11, wherein the metes and bounds description specifies one or more land blocks/sections.

18. A data processing system, comprising:
one or more hardware processors;
one or more memory modules communicably coupled to the one or more hardware processors; and
an execution system operable on the one or more hardware processors to perform operations comprising:
obtaining a digital version of a state filing pertaining to a deal involving transacted acreage;
obtaining metes and bounds description of the transacted acreage from the digital version;
using the metes and bounds description to generate a geographic information system shapefile specifying non-topological geometry of the transacted acreage; and
using the shapefile to cause the geographic information system to display a map that visually indicates at least boundaries of the transacted acreage as one or more polygons overlaid on the map display.

19. The data processing system of claim 18, wherein the state filing comprises an assignment, or an assignment and bill of sale.

20. The data processing system of claim 12, wherein the operation of obtaining the digital version of the state filing is based, at least in part, on automatically downloading the digital version of the state filing from a website.

21. The data processing system of claim 18, wherein the operation of obtaining the digital version of the state filing is based, at least in part, on using a machine learning binary classifier to classify the state filing is either a) relevant or b) not relevant to a deal involving transacted acreage.

22. The data processing system of claim 18, wherein the digital version of the state filing is text based; and wherein the processing the digital version of the state filing is based, at least in part, on parsing text of the digital version of the state filing to extract from the state filing the metes and bounds description.

23. The data processing system of claim 22, wherein the execution system is operable on the one or more hardware processors to perform operations further comprising performing optical character recognition on another digital version of the state filing to produce the text-based digital version of the state filing.

24. The data processing system of claim 18, wherein the metes and bounds description specifies one or more land blocks/sections.
